(19) United States
(12) Patent Application Publication
(10) Pub. No.: US 2018/0225377 A1
(43) Pub. Date: Aug. 9, 2018

(54) METHOD, SERVER AND TERMINAL FOR ACQUIRING INFORMATION AND METHOD AND APPARATUS FOR CONSTRUCTING DATABASE

(71) Applicant: Baidu Online Network Technology (Beijing) Co., Ltd., Beijing (CN)

(72) Inventor: Jun Li, Beijing (CN)

(73) Assignee: Baidu Online Network Technology (Beijing) Co., Ltd., Beijing (CN)

(21) Appl. No.: 15/504,056

(22) PCT Filed: Sep. 15, 2015
(86) PCT No.: PCT/CN2015/089586

§ 371 Date: Feb. 15, 2017

(30) Foreign Application Priority Data
Jun. 17, 2015 (CN) 201510336439.6

(51) Int. Cl. G06F 17/30

(52) U.S. Cl. CPC G06F 17/30831; G06F 17/3084; G06F 17/3079; G06F 17/30867

(57) ABSTRACT

A method, server and terminal for acquiring information, and a method and apparatus for constructing a database. A specific embodiment of the method includes: acquiring a video image and a position of a cursor in the video image; detecting whether the cursor is located in an item display area within the video image based on the position of the cursor; if yes, acquiring item information associated with the item display area from a preset database; and sending the item information to a terminal for the terminal to present the item information. According to this embodiment, relevant item information may be presented to the user based on the item appearing in the video image, thus the efficiency and accuracy of information acquisition are improved.

### CROSS-REFERENCE TO RELATED APPLICATIONS

This application is a U.S. National Stage of International Application No. PCT/CN2015/089586, filed Sep. 15, 2015, which claims the benefit of Chinese Patent Application No. 201510336439.6, filed Jun. 17, 2015, both of which are incorporated herein by reference in their entireties.

### CROSS-REFERENCE TO RELATED APPLICATION

This application claims the priority of Chinese Patent Application No. 201510336439.6, entitled “Method, Server and Terminal For Acquiring Information and Method and Apparatus For Constructing Database,” filed on Jun. 17, 2015, the content of which is incorporated herein by reference in its entirety.

### TECHNICAL FIELD

The application relates to the field of computer technology, particularly relates to the field of terminal technology, and more particularly to a method, server and terminal for acquiring information, and a method and apparatus for constructing a database.

### BACKGROUND

A video generally contains numerous items, for example clothing such as clothes, hats, shoes, and scarves, articles for daily use such as cups, throw pillows, and bookshelves. When watching a video, one may be interested in certain items contained therein and want to know specific information about these items, for example, brands, models, prices, and purchase links. The brands, models, etc. may not be clearly visible in the video, and therefore the prices, the purchase links, etc. of the items may not be available.

Existing methods for acquiring item information generally require a user to enter keywords based on an item seen in a video, for example, a name, a style, of the item for Internet search, in order to obtain the item the user is interested in. Such methods, however, require the user to switch from the video page being watched to an item search page. The user is required to filter the information during the search to find items more closer to the item appearing in the video, thus the efficiency is low. In addition, when the keywords identified by the user are not accurate, the accuracy of the information may also be affected.

### SUMMARY

In view of the above drawbacks or deficiencies in the existing technology, it is desirable to provide a solution to present information of related items in video images based on the items appearing in the video images. In order to achieve the above one or more objectives, the present application provides a method, server and terminal for acquiring information, and a method and apparatus for constructing a database.

In a first aspect, the present application provides a method for acquiring information, comprising: acquiring a video image and a position of a cursor in the video image; detecting whether the cursor is located in an item display area within the video image based on the position of the cursor; if yes, acquiring item information associated with the item display area from a preset database; and sending the item information to a terminal for the terminal to present the item information.

In a second aspect, the present application provides another method for acquiring information, comprising: acquiring a video image and a position of a cursor in the video image; acquiring item information associated with an item display area when the cursor is located in the item display area within the video image; and presenting the item information.

In a third aspect, the present application provides a method for constructing a database, comprising: acquiring a video image; determining whether the video image contains an item display area; if yes, then determining position features and image features of the item display area;

Acquiring item information associated with the item display area from a network based on the image features; and storing the video image containing the item display area and corresponding position features and item information in a preset database.

In a fourth aspect, the present application provides a server, comprising: a first acquisition module for acquiring a video image and a position of a cursor in the video image; a detection module for detecting whether the cursor is located in an item display area within the video image based on the position of the cursor; a second acquisition module for acquiring item information associated with the item display area from a preset database in response to the cursor being located in the item display area within the video image; and a sending module for sending the item information to a terminal for the terminal to present the item information.

In a fifth aspect, the present application provides a terminal, comprising: a position acquisition module for acquiring a video image and a position of a cursor in the video image; an information acquisition module for acquiring item information associated with an item display area when the cursor is located in the item display area within the video image; and an information presentation module for presenting the item information.

In a sixth aspect, the present application provides an apparatus for constructing a database, comprising: an image acquisition module for acquiring a video image; an image determination module for determining whether the video image contains an item display area; a feature determination module for determining position features and image features of the item display area in response to the video image containing the item display area; an information acquisition module for acquiring item information associated with the item display area from a network based on the image features; and a data storage module for storing the video image containing the item display area and corresponding position features and item information in a preset database.

With the method, server and terminal for acquiring information, and the method and apparatus for constructing a database provided by the present application, it is possible to first acquire a video image and a position of a cursor in the video image, and then detect whether the cursor is located in an item display area within the video image based on the cursor position, if the cursor is located in the item display area within the video image, acquire item information associated with the item display area from a preset database and finally send the item information to a terminal for the terminal to present the item information. According to the present application, relevant item information may be presented to the user based on the item appearing in the video image, thus the efficiency and accuracy of information acquisition are improved.

### BRIEF DESCRIPTION OF THE DRAWINGS

Other features, objectives and advantages of the present application will become more apparent upon reading the detailed description of non-limiting embodiments with reference to the accompanying drawings, wherein:

FIG. 1 shows an exemplary system architecture 100 in which the present application may be implemented;

FIG. 2 shows a flowchart of a method for acquiring information according to one embodiment of the present application;

FIG. 3 shows an exemplary schematic diagram of presenting item information in a video image;

FIG. 4 shows a flowchart of another method for acquiring information according to one embodiment of the present application;

FIG. 5 shows a flowchart of a method for constructing a database according to one embodiment of the present application;

FIG. 6 shows a schematic architectural diagram of functional modules of a server according to one embodiment of the present application;

FIG. 7 shows a schematic architectural diagram of functional modules of a terminal device according to one embodiment of the present application;

FIG. 8 shows a schematic architectural diagram of functional modules of an apparatus for constructing a database according to one embodiment of the present application;

FIG. 9 shows a schematic architectural diagram of functional modules of a system for acquiring information according to one embodiment of the present application; and

FIG. 10 shows a schematic structural diagram of a computer system 1000 adapted to implement the terminal device or server of the embodiments of the present application.

### DETAILED DESCRIPTION OF EMBODIMENTS

The present application will be further described below in detail in combination with the accompanying drawings and the embodiments. It should be appreciated that the specific embodiments described herein are merely used for explaining the relevant disclosure, rather than limiting the disclosure. In addition, it should be noted that, for the ease of description, only the parts related to the relevant disclosure are shown in the accompanying drawings.

It should also be noted that the embodiments in the present application and the features in the embodiments may be combined with each other on a non-conflict basis. The present application will be described below in detail with reference to the accompanying drawings and in combination with the embodiments.

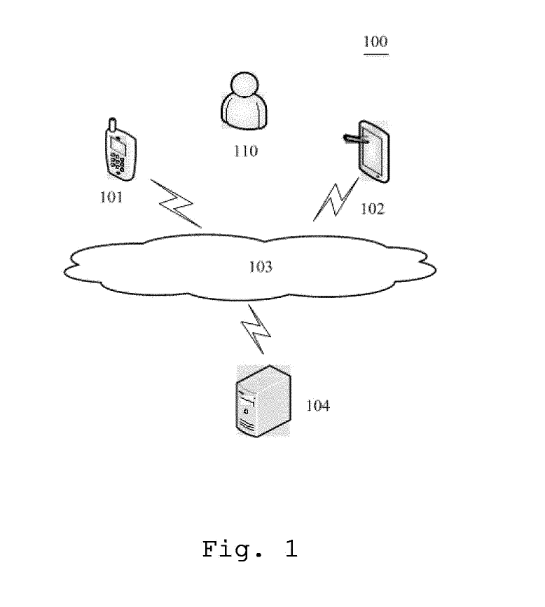

FIG. 1 shows an exemplary architecture of a system 100 which may be applied to an embodiment of the present application.

As shown in FIG. 1, the system architecture 100 may include terminal devices 101, 102, a network 103 and a server 104. The network 103 serves as a medium providing a communication link between the terminal devices 101, 102 and the server 104. The network 103 may include various types of connections, such as wired or wireless transmission links, or optical fibers or the like.

The user 110 may use the terminal devices 101, 102 to interact with the server 104 through the network 103, in order to transmit or receive messages, etc. For example, the user may use the terminal devices 101, 102 to acquire video information and/or item information, etc., from the sever 104 through the network 103. Various communication client applications, such as, instant messaging tools, mailbox clients, social platform software, etc., may be installed on the terminal devices 101, 102.

The terminal devices 101, 102 may be various electronic devices, including but not limited to, personal computers, smart phones, tablet computers, personal digital assistant, etc.

The server 104 may be a server providing various services. The server may perform a corresponding processing, such as store or analysis, on received data, and return a processing result to the terminal devices.

It should be noted that, the method for acquiring information provided by the embodiments of the present application may be executed by the terminal devices 101, 102, and may also be executed by the server 104. In some embodiments, a position of a cursor may be acquired by the server. When the cursor is detected to be currently located in an item display area within a video image, item information associated with the item display area may be acquired from a preset database. After acquiring the item information from the preset database, the server may send the item information to the terminal devices for the terminal devices to present the item information.

It should be appreciated that, the numbers of the terminal devices, the networks and the servers in FIG. 1 are merely illustrative. Any number of terminal devices, networks and servers may be provided based on the actual requirements.

Further referring to FIG. 2, a flow 200 of a method for acquiring information according to an embodiment of the present application is illustrated. As shown in FIG. 2, the method for acquiring information comprises the following steps.

As indicated in FIG. 2, at step 201 a video image and a position of a cursor in the video image are acquired.

The user may watch videos, for example, TV movies, variety shows, sports, through a terminal device with a display screen. During the video play, some items may appear in a given video image, for example, clothes, shoes, worn by a person appearing in the video image. If the user is interested in an item appearing in the video image, she may move the cursor to the area displaying the item in the video image by moving a mouse or gliding on a touch screen so as to acquire information associated with the item displayed in this area.

In this embodiment, the server may acquire the video image being played on the terminal device and the position of the cursor in the video image.

Step 202: detect whether the cursor is located in an item display area within the video image based on the position of the cursor.

After the video image being played on the terminal device and the position of the cursor in the video image are acquired at step 201, whether the cursor is currently located in an item display area within the video image may be detected. There may be item display areas and other areas in one video image. An item display area for example may comprise an area displaying the clothes, shoes, hats, etc. while other areas for example may include areas displaying plants, rivers, buildings, etc. In general, the cursor may be displayed on the screen of an electronic device. When the user watches a video in a full screen viewing mode, the cursor may be hidden. If the user sees an item of interest and wants to acquire detailed information thereof, the user may enable the cursor to be displayed on the screen by moving the mouse or touching the touch screen. The position of the cursor maybe changed by moving the mouse or gliding on the touch screen. While watching a video, the cursor may be located in the item display area within the video image, or in other area within the video image, or located outside of the video image. The server may detect the current position of the cursor to determine whether the cursor is located in the item display area within the video image.

Alternatively, the server may first search the current video image in a preset database to determine whether the video image is stored in the preset database. If the current video image is stored in the preset database, it may be determined to be a video image containing an item display area. If the current video image is determined to be a video image containing an item display area, position features of the item display area may be acquired from the preset database. Whether the cursor is located in the item display area within the current video image is detected afterwards based on the position features and the position of the cursor.

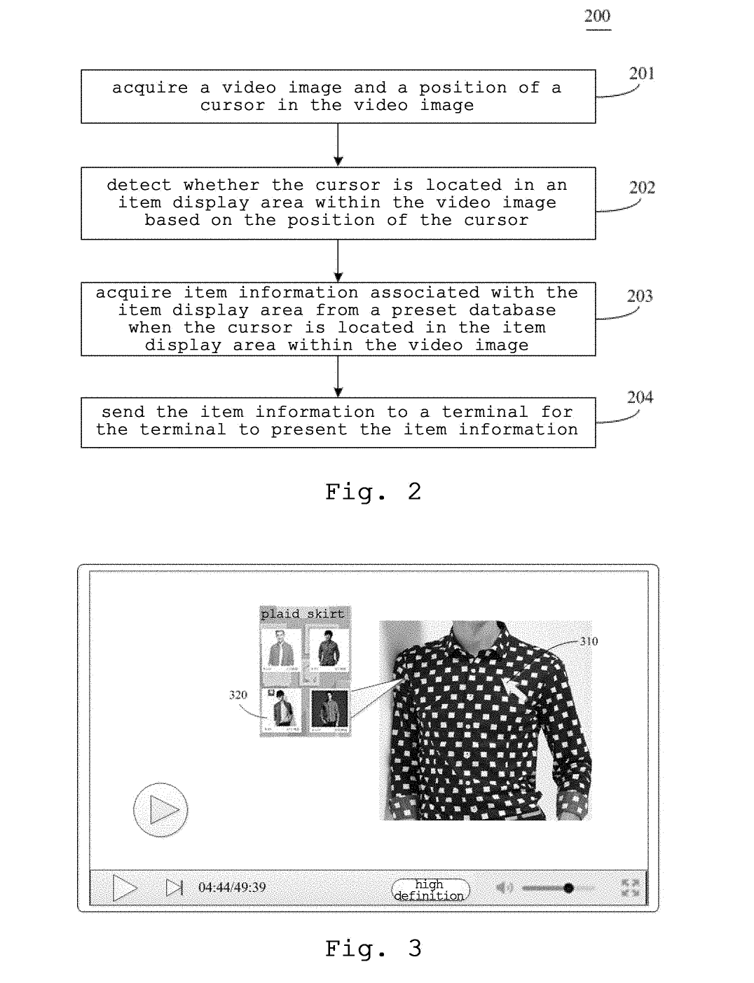

Referencing to FIG. 3, it shows an exemplary schematic diagram of presenting the item information in the video image. As shown in FIG. 3, when the cursor is located in a position 310 shown in the figure, the server may detect that the cursor is located in the item display area within the video image. For example, in FIG. 3, the cursor is located in the area displaying a piece of clothing worn by a person.

Step 203: acquire the item information associated with the item display area from the preset database in response to the cursor being located in the item display area within the video image.

In this embodiment, when the cursor is detected to be located in the item display area within the current video image at step 201, the server may acquire the item information associated with the item display area from a pre-constructed database. The pre-constructed database may be stored in the server or other storage devices. When the database is stored in other storage devices, the server may establish connections with the storage devices so as to acquire information therefrom. When the user moves the cursor to the item display area, the user may be deemed to be interested in the item displayed in this area, thus the server may acquire the item information associated with the item displayed in this area to assist the user to become knowledgeable of, or purchase, this item. For example, the server may acquire an item image matched with the item display area from the preset database based on image features of the item display area and take item information corresponding to this item image as the item information associated with the item display area.

As shown in FIG. 3, the cursor is located in the area displaying a piece of clothing worn by the person, then information related to this piece of clothing, for example, a cloth type, a cloth price, pictures of similar clothes, may be acquired.

Step 204: send the item information to the terminal, in order to present the item information by the terminal.

In this embodiment, after the item information associated with the item display area within the video image is acquired at step 203, the item information may be sent to the terminal device in order to present the item information in the video image.

With reference to FIG. 3, after the information related to the piece of clothing worn by the person is acquired at step 203, the information, such as clothing information 320 shown in FIG. 3, may be sent to the terminal device and presented in the video image. As shown in FIG. 3, the clothing information displayed in the video image may comprise: the cloth name, the cloth image, the cloth price, the purchase link, etc. In the example as shown in FIG. 3, the user may access a corresponding link by clicking the image of the piece of clothing, to view more detailed information, for example, trading volume, user evaluations.

With the method for acquiring information provided by this embodiment, it is possible to first acquire the video image and the position of the cursor in the video image, then detect whether the cursor is located in the item display area within the video image based on the cursor position, and then acquire the item information associated with the item display area from the preset database if the answer is yes, and finally send the item information to the terminal for the terminal to present the item information. According to the present application, relevant item information may be presented to the user based on the item appearing in the video image, thus the efficiency and accuracy of information acquisition are improved.

Further referring to FIG. 4, a flow 400 of a method for acquiring information according to another embodiment of the present application is illustrated. As shown in FIG. 4, the method for acquiring information comprises the following steps.

Step 401: acquire a video image and a position of a cursor in the video image.

In this embodiment, the terminal device may acquire the video image being played on the terminal device and the position of the cursor in the video image.

Step 402: acquire item information associated with an item display area when the cursor is located in the item display area within the video image.

In this embodiment, the terminal device may acquire the item information associated with the item display area when the cursor is located in the item display area within the video image.

In one implementation, the terminal device may search the current video image in a preset database to determine whether the video image is stored in the preset database. If the current video image is stored in the preset database, it maybe determined to be a video image containing an item display area. If the current video image is determined to be a video image containing the item display area, position features of the item display area maybe acquired from the preset database. Whether the cursor is located in the item display area within the current video image is detected afterwards based on the position features and the position of the cursor. The terminal device may acquire the item information associated with the item display area from a pre-constructed database when the cursor is located in the item display area within the video image.

In another implementation, the terminal device may send the acquired video image and the position of the cursor to the server which detects whether the cursor is located in the item display area within the video image. The server may acquire the item information associated with the item display area and send it to the terminal in response to the cursor being located in the item display area within the video image.

Step 403: present the item information.

In this embodiment, after acquiring the item information, the terminal may present the item information in the video image for viewing by the user. For example, the item information may be presented in a suspended form in the video image.

Alternatively, the video being played may be paused when the item image is displayed in order to not affect the user watching the video. After the user has viewed the item information displayed and closed an item information page, the terminal device may continue the video automatically in response to a closure of a item display page, or the user may manually click a play button to continue the video play.

In an optional implementation of this embodiment, if item information of a plurality of items is received, the terminal device may present the item information of some or all of the items in the video image in sequence based on a matching score between the item image of each item and the item display area. For example, the server may acquire an item image matching with the item display area from the preset database based on the image features of the item display area. For example, if the matching score of an item image reaches a certain threshold (for example 80%), the item image may be determined to be matched with the item display area within the video image. Since there are some similar items, the server may acquire a plurality of item images matching with the item display area and send them all to the terminal device. The matching score between these item images and the item display area within the video image is greater than a preset threshold, but usually the corresponding matching score between each of the item images and the item display area may not be exactly the same. Therefore, the terminal device may present corresponding item information in the video image in sequence based on the matching socre between each of the item images and the item display area. Alternatively or additionally, the terminal device may preset a threshold for a number of the item images to be displayed, for example at most 4. When the number of items acquired is less than or equal to the preset threshold, the item information of all the items may be presented in the video image. When the number of items acquired is greater than the preset threshold, the terminal device may present the item information of some of the items in the video image in sequence based on the matching score between each of the item images and the item display area within the video image. For example, if the preset threshold for the number is 4, and the number of item images having a matching score greater than the threshold is 6, then item information of 4 items having a higher matching score may be presented in the video image, and 4 item images may be arranged in sequence from large value to small value based on the matching score.

In an optional implementation of this embodiment, the item information may comprise at least one of the following: an item image, an item name, an item model, an item price and a purchase link. For example, when the user moves the cursor to a piece of clothing worn by the person in the video image, the user may be deemed to want to know some information about or purchase this piece of clothing. Therefore, the terminal device may acquire information related to this piece of clothing and may further acquire the purchase link of this piece of clothing directly, then the user may click the purchase link to access a related web page to know detailed information of this piece of clothing.

In this embodiment, step 401 in the above implementation flow 400 is substantially the same as step 201 in the implementation flow 200, thus the detailed description thereof will be omitted.

With the method for acquiring information provided in this embodiment, it is possible to first acquire the video image and the position of the cursor in the video image, and then acquire the item information associated with the item display area when the cursor is located in the item display area within the video image and present the item information. According to this embodiment, relevant item information may be presented to the user based on the item appearing in the video image, thus the efficiency and accuracy of information acquisition are improved.

while operations of the method of the present disclosure are depicted in a particular order in the drawings, it should be understood that such operations are not required or suggested to be performed in the particular order shown, or that not all illustrated operations are needed to be performed, to achieve desirable results. In contrast, some steps described in the flowchart may have different implementing sequences. Additionally or optionally, some operations may be omitted, several steps may be integrated into one step, and/or one step may be divided into several steps.

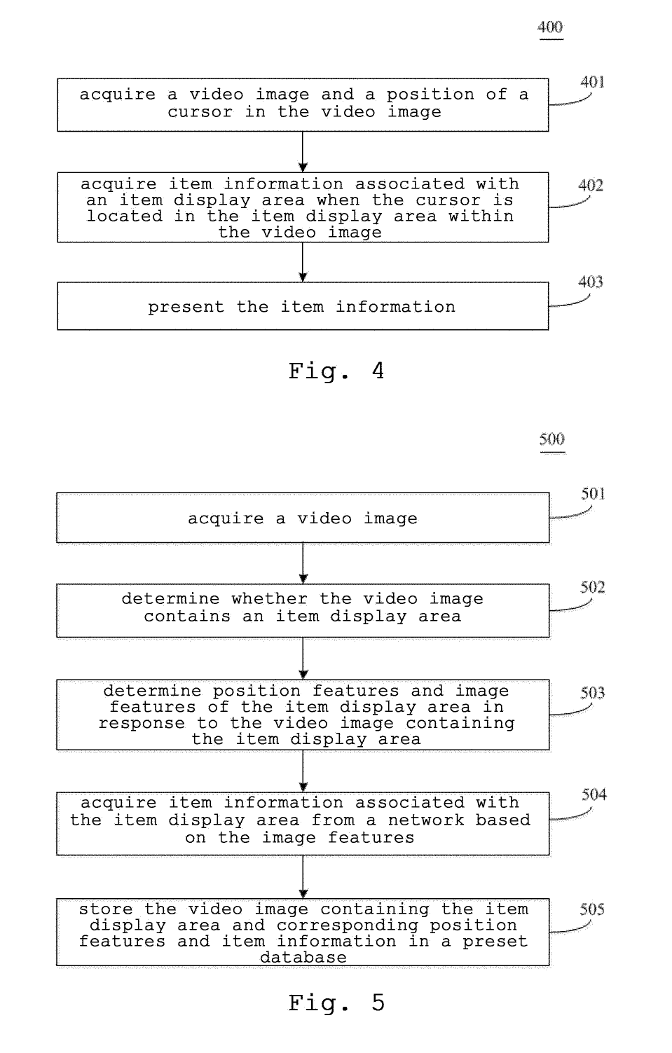

Further referring to FIG. 5, a flow 500 of a method for constructing a database according to an embodiment of the present application is illustrated. As shown in FIG. 5, the method for constructing a database comprises the following steps.

Step 501: acquire a video image.

In this embodiment, a large amount of video resources may be acquired first of all, and video images may be extracted therefrom as materials for constructing a preset database. Since each video comprises a plurality of image frames sorted in chronological order, each image frame maybe extracted directly from corresponding video to obtain a video image. In order to ensure the comprehensiveness and richness of the database, as many as possible of various types of videos may be acquired, for example, the videos may be acquired from various video websites.

Step 502: determine whether the video image contains an item display area.

In this embodiment, each video image acquired at step 501 may be identified to determine whether the video image contains an item display area. For example, a deep convolutional neural network (DCNN) algorithm may be used to identify the video image. A trained deep convolutional neural network (DCNN) maybe used to determine whether a specified item is contained, and the training process is as follows. First of all, an input video image may be divided into a plurality of receptive fields, and then a convolution kernel is convolved with each of the receptive fields. A plurality of output images will be obtained from one video image after convolution. After that, a plurality of pixels of each output image obtained are merged into one pixel. The number of each video image increases after being processed, for example n, and the size decreases, for example 1, obtaining a feature vector X (x₁,x₂, . . . xₙ) of the input video image. The feature vector may be fully connected with m output nodes to obtain a confidence for each output node and a maximum value thereof as a classification result. After that, a difference value between the classification result and a label result is obtained until convergence occurs, that is, the difference value is smaller than a given threshold, then the training ends. For unknown input video frames, a confidence of Y and N, i.e., c_{y} and cₙ, maybe obtained by the neural network obtained above. If c_{y} is greater than cₙ, the input video frames are deemed to contain an item; if no, the input video frames are deemed not to contain an item.

Step 503: determine position features and image features of the item display area in response to the video image containing the item display area.

When the video image is determined to contain the item display area at step 502, further identification may be performed to the video image to extract the position features and image features of the item display area. For example, the video image may be identified according to the deep convolutional neural network algorithm at step 502 to extract the position and image features of the video image. In the above implementation method, after the video image is subjected to convolution and down-sampling, the feature vector X of the video image may be obtained, which is the image feature of the video image.

An algorithm for extracting position features of the video image may be performed based on the above implementation method. Position information may be represented in a rectangle format, such as P=(x, y, w, h), where x and y represent a horizontal coordinate and a vertical coordinate of an upper left corner of the rectangle, respectively; and w and h represent a length and a width of the rectangle, respectively. In other words, the output position features maybe represented by 4 nodes. The training process is as follows. After the feature vector X of the video image is obtained by the above implementation method, it may be fully connected with the 4 output nodes to obtain 4 output values Y. Then, a distance between Y and a calibrated rectangular is compared with a given threshold, if the distance is smaller than the given threshold, it indicates that convergence have occurred. For the test of a video frame, the DCNN obtained above through training may be used to derive the output values Y, which are the position features of the video image.

Step 504: acquire item information associated with the item display area from a network based on the image features.

In this embodiment, the item information associated with the item display area may be acquired from the network based on the image features of the item display area extracted at step 503. For example, item images may be acquired from the network by web crawlers or through cooperation with electronic services suppliers, and the item information of the items in each item image may be acquired by electronic services suppliers. After the item images are acquired, identification maybe performed to the item images, for example, identification may be performed to the item images according to the above deep convolutional neural network algorithm to extract the image features of the item images. Then the image features of the item display area are matched against the image features of item images. When the matching score between the image features of a certain item image and the image features of the item display area reaches a certain threshold (for example 80%), the item image may be determined to be matched with the item display area.

Alternatively or additionally, the above threshold may be the same or different for different item display areas. For example, the same threshold may be set for different item display areas. Upon image matching, all the item images may be determined to be matched with the item display areas as long as they have a matching score greater than the set threshold. When the threshold is set to be the same, there may be great differences between the acquired item images matched with the item display areas since the items in different item display areas are different and the numbers of item images on the network may be greatly different. In another implementation, in order to acquire a similar number of item images matched with the item display areas, different thresholds may be set for different item display areas to acquire matched item images. For example, a larger threshold may be set for common items as there are more images of these items on the network; while a smaller threshold may be set for uncommon items as there are less images of these items on the network. In the process of item image matching, the threshold for the matching score may also be determined according to image matching results and the desired number of images matched with the item display areas.

After the item images matched with the item display areas are acquired, the item display areas may be allocated with the item information associated therewith based on the item information of the respective items in the item images acquired by the electronic services suppliers. In particular, the information of items displayed in the item images matched with the item display areas may be associated with the item display areas.

Step 505: store the video image containing the item display area and corresponding position features and item information in a preset database.

In this embodiment, the video image containing the item display area, the position features extracted and the item information associated with the item display area may be stored in the preset database.

Further referring to FIG. 6, a schematic architectural diagram of functional modules of a server 600 according to one embodiment of the present application is shown.

As shown in FIG. 6, the server 600 according to this embodiment comprises: a first acquisition module 610, a detection module 620, a second acquisition module 630 and a sending module 640. Specifically, the first acquisition module 610 is used for acquiring a video image and a position of a cursor in the video image. The detection module 620 is used for detecting whether the cursor is located in an item display area within the video image based on the position of the cursor. The second acquisition module 630 is used for acquiring item information associated with the item display area from a preset database in response to the cursor being located in the display area of the video image. The sending module 640 is used for sending the item information to a terminal in order for the terminal to present the item information.

In an optional implementation of this embodiment, the detection module 620 is also used for detecting whether the cursor is located in the item display area within the video image in the following steps: searching the video image in the preset database; acquiring the position features of the item display area within the video image found; detecting whether the cursor is located in the item display area within the video image based on the position features and the position of the cursor.

With the server provided by this embodiment, first, the first acquisition module may acquire a video image and a position of a cursor in the video image, then the detection module detects whether the cursor is located in an item display area within the video image based on the position of the cursor, after that, the second acquisition module acquires item information associated with the item display area from a preset database in response to the cursor being located in the display area of the video image, and finally the sending module sends the item information to a terminal for the terminal to present the item information, such that relevant item information may be presented to the user based on the item appearing in the video image, and the efficiency and accuracy of information acquisition are improved.

It will be appreciated that, the units or modules included in the server shown in FIG. 6 correspond to the respective steps of the method described with reference to FIG. 2. Therefore, the operations and features described above with respect to the method are also applied to the device shown in FIG. 6 and the modules comprised therein, thus the detailed description thereof will be omitted.

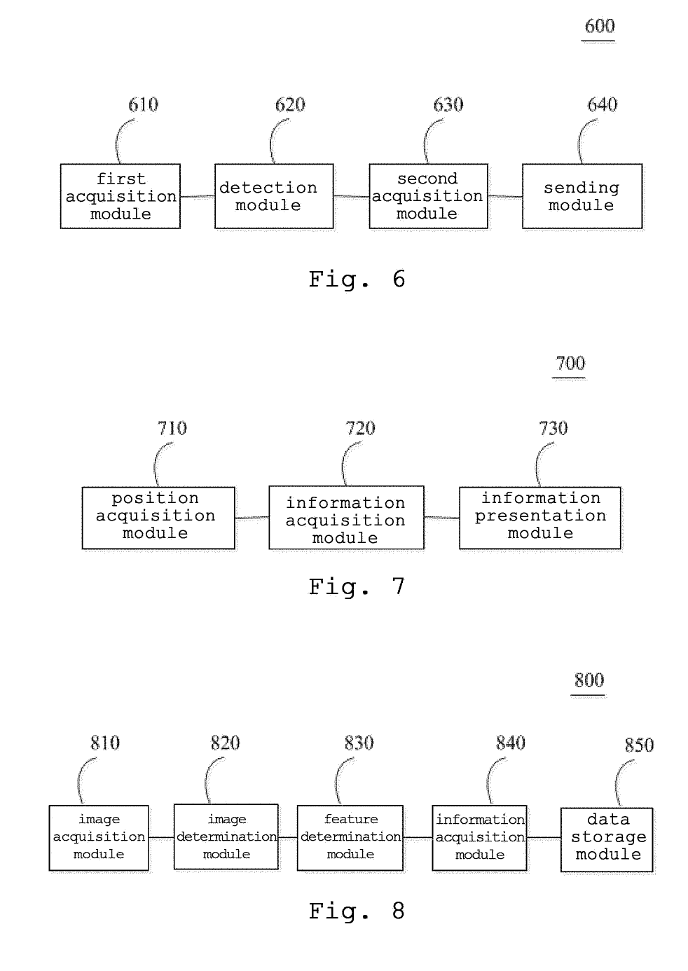

Further referring to FIG. 7, a schematic architectural diagram of functional modules of a terminal device 700 according to one embodiment of the present application is illustrated.

As shown in FIG. 7, the terminal device 700 provided by this embodiment comprises: a position acquisition module 710, an information acquisition module 720 and an information presentation module 730. Specifically, the position acquisition module 710 is used for acquiring a video image and a position of a cursor in the video image. The information acquisition module 720 is used for acquiring item information associated with an item display area when the cursor is located in the item display area within the video image. The information presentation module 730 is used for presenting the item information.

In an optional implementation of this embodiment, the information acquisition module 720 is also used for acquiring the item information associated with the item display area in the following steps: searching the video image in a preset database; acquiring position features of the item display area within the video image found; detecting whether the cursor is located in the item display area within the video image based on the position of the cursor; and if yes, acquiring the item information associated with the item display area from the preset database.

In an optional implementation of this embodiment, the information acquisition module 720 is also used for acquiring the item information associated with the item display area in the following steps: sending the video image and the position of the cursor to a server; and receiving the item information associated with the item display area sent by the server when the cursor is located in the item display area within the video image.

In an optional implementation of this embodiment, the terminal device 700 further comprises: a pause module for pausing the video in response to the presenting the item information; and a continue-playing module for continuing the video in response to a closure of a display page of the item information.

In an optional implementation of this embodiment, if the item information of a plurality of items are acquired, the information presentation module 730 is also used for: presenting the item information of some or all of the items in sequence based on a matching score between each item image of items and the item display area.

In an optional implementation of this embodiment, the item information comprises at least one of the following: an item image, an item name, an item model, an item price and a purchase link.

It will be appreciated that, the units or modules included in the terminal device shown in FIG. 7 correspond to the respective steps of the method described with reference to FIG. 4. Therefore, the operations and features described above with respect to the method are also applied to the device shown in FIG. 7 and the modules comprised therein, thus the detailed description thereof will be omitted.

Further referring to FIG. 8, a schematic architectural diagram of functional modules of an apparatus 800 for constructing a database according to one embodiment of the present application is illustrated.

As shown in FIG. 8, the apparatus 800 for constructing a database provided by this embodiment comprises: an image acquisition module 810, an image determination module 820, a feature determination module 830, an information acquisition module 840 and a data storage module 850. Specifically, the image acquisition module 810 is used for acquiring a video image. The image determination module 820 is used for determining whether the video image contains an item display area. The feature determination module 830 is used for determining position features and image features of the item display area in response to the video image containing the item display area. The information acquisition module 840 is used for acquiring item information associated with the item display area from a network based on the image features. The data storage module 850 is used for storing the video image containing the item display area and corresponding position features and item information in a preset database.

It will be appreciated that, the units or modules included in the apparatus shown in FIG. 8 correspond to the respective steps of the method described with reference to FIG. 5. Therefore, the operations and features described above with respect to the method are also applied to the device shown in FIG. 8 and the modules comprised therein, thus the detailed description thereof will be omitted.

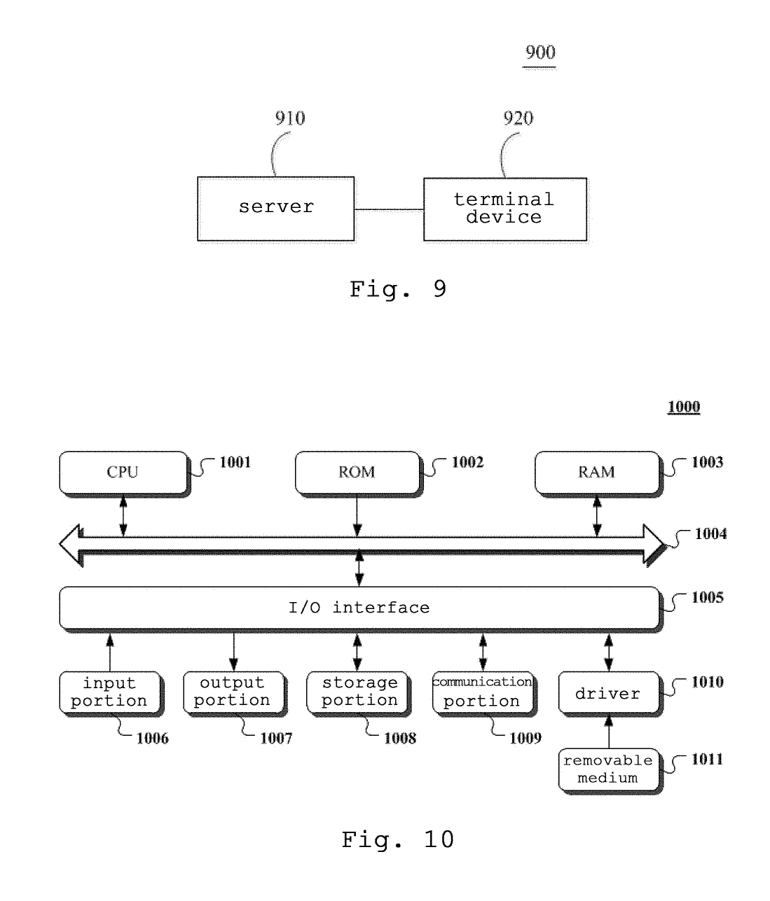

Further referring to FIG. 9, a schematic architectural diagram of functional modules of a system 900 for acquiring information according to one embodiment of the present application is illustrated.

As shown in FIG. 9, the system 900 for acquiring information provided by this embodiment comprises a server 910 and a terminal device 920. Specifically, the server 910 is used for acquiring a video image and a position of a cursor in the video image; detecting whether the cursor is located in an item display area within the video image based on the position of the cursor; acquiring item information associated with the item display area from a preset database in response to the cursor being located in the item display area within the video image; and sending the item information to the terminal for the terminal to present the item information. The terminal device 920 is used for acquiring the video image and the position of the cursor in the video image; acquiring the item information associated with the item display area when the cursor is located in the item display area within the video image; and presenting the item information.

Referring to FIG. 10, a schematic structural diagram of a computer system 1000 adapted to implement a terminal device or a server of the embodiments of the present application is illustrated.

As shown in FIG. 10, the computer system 1000 includes a central processing unit (CPU) 1001, which may execute various appropriate actions and processes in accordance with a program stored in a read-only memory (ROM) 1002 or a program loaded into a random access memory (RAM) 1003 from a storage portion 1008. The RAM 1003 also stores various programs and data required by operations of the system 1000. The CPU 1001, the ROM 1002 and the RAM 1003 are connected to each other through a bus 1004. An input/output (I/O) interface 1005 is also connected to the bus 1004.

The following components are connected to the I/O interface 1005: an input portion 1006 including a keyboard, a mouse etc.; an output portion 1007 comprising a cathode ray tube (CRT), a liquid crystal display device (LCD), a speaker etc.; a storage portion 1008 including a hard disk and the like; and a communication portion 1009 comprising a network interface card, such as a LAN card and a modem. The communication portion 1009 performs communication processes via a network, such as the Internet. A driver 1010 is also connected to the I/O interface 1005 as required. A removable medium 1011, such as a magnetic disk, an optical disk, a magneto-optical disk, and a semiconductor memory, may be installed on the driver 1010, to facilitate the search of a computer program from the removable medium 1011, and the installation thereof on the storage portion 1008 as needed.

In particular, according to an embodiment of the present disclosure, the processes described above with reference to flowcharts may be implemented in a computer software program. For example, an embodiment of the present disclosure includes a computer program product, which comprises a computer program that is tangibly embedded in a machine-readable medium. The computer program comprises program codes for executing the methods illustrated in the flowcharts. In such an embodiment, the computer program may be downloaded and installed from a network via the communication portion 1009, and/or may be installed from the removable media 1011.

The flowcharts and block diagrams in the figures illustrate architectures, functions and operations that may be implemented according to the system, the method and the computer program product of the various embodiments of the present disclosure. In this regard, each block in the flowcharts and block diagrams may represent a module, a program segment, or a code portion. The module, the program segment, or the code portion comprises one or more executable instructions for implementing the specified logical function. It should be noted that, in some alternative implementations, the functions denoted by the blocks may occur in a sequence different from the sequences shown in the figures. For example, in practice, two blocks in succession may be executed, depending on the involved functionalities, substantially in parallel, or in a reverse sequence. It should also be noted that, each block in the block diagrams and/or the flowcharts and/or a combination of the blocks may be implemented by a dedicated hardware-based system executing specific functions or operations, or by a combination of a dedicated hardware and computer instructions.

The units or modules involved in the embodiments of the present application may be implemented by way of software or hardware. The described units or modules may also be provided in a processor, for example, described as: a processor, comprising a first acquisition module, a detection module, a second module and a sending module, where the names of these units or modules are not considered as a limitation to the units or modules. For example, the acquisition module may also be described as “a module for detecting whether a cursor is located in an item display area within a video image based on a position of a cursor”.

In another aspect, the present application further provides a computer readable storage medium. The computer readable storage medium may be the computer readable storage medium included in the apparatus in the above embodiments, or a stand-alone computer readable storage medium which has not been assembled into the terminal. The computer readable storage medium stores one or more programs. The programs are used by one or more processors to execute the method for acquiring information described in the present application.

The foregoing is only a description of the preferred embodiments of the present application and the applied technical principles. It should be appreciated by those skilled in the art that the inventive scope of the present application is not limited to the technical solutions formed by the particular combinations of the above technical features. The inventive scope should also cover other technical solutions formed by any combinations of the above technical features or equivalent features thereof without departing from the concept of the disclosure, such as, technical solutions formed by replacing the features as disclosed in the present application with (but not limited to), technical features with similar functions.

1. A method for acquiring information, comprising:
acquiring a video image and a position of a cursor in the video image;
detecting whether the cursor is located in an item display area within the video image based on the position of the cursor;
if yes, acquiring item information associated with the item display area from a preset database; and
sending the item information to a terminal for the terminal to present the item information.

2. The method according to claim 1, wherein the detecting whether the cursor is located in the item display area within the video image based on the position of the cursor comprises:
searching the video image in the preset database;
acquiring position features of the item display area within the video image found; and
detecting whether the cursor is located in the item display area within the video image based on the position features and the position of the cursor.

3. A method for acquiring information, comprising:
acquiring a video image and a position of a cursor in the video image;
acquiring item information associated with an item display area when the cursor is located in the item display area within the video image; and
presenting the item information.

4. The method according to claim 3, wherein the acquiring the item information associated with the item display area when the cursor is located in the item display area within the video image comprises:
searching the video image in a preset database;
acquiring position features of the item display area within the video image found;
detecting whether the cursor is located in the item display area within the video image based on the position features and the position of the cursor; and
if yes, acquiring the item information associated with the item display area from a preset database.

5. The method according to claim 3, wherein the acquiring the item information associated with the item display area when the cursor is located in the item display area within the video image comprises:
sending the video image and the position of the cursor to a server; and
receiving, the item information associated with the item display area sent by the server, when the cursor is located in the item display area within the video image.

6. The method according to claim 3, further comprising:
pausing a video in response to the presenting the item information; and
continuing the video in response to closing a display page of the item information.

7. The method according to claim 3, wherein if the item information of a plurality of items is acquired, and the presenting comprises:
presenting the item information of some or all of the items in sequence based on a matching score between each item image of the items and the item display area.

8. The method according to claim 3, wherein the item information comprises at least one of the following: an item image, an item name, an item model, an item price and a purchase link.

9. A method for constructing a database, comprising:
acquiring a video image;
determining whether the video image contains an item display area;
if yes, determining position features and image features of the item display area;
acquiring item information associated with the item display area from a network based on the image features; and
storing the video image containing the item display area and corresponding position features and item information in a preset database.

10. A server, comprising:
a first acquisition module for acquiring a video image and a position of a cursor in the video image;
a detection module for detecting whether the cursor is located in an item display area within the video image based on the position of the cursor;
a second acquisition module for acquiring item information associated with the item display area from a preset database in response to the cursor being located in the item display area within the video image; and
a sending module for sending the item information to a terminal for the terminal to present the item information.

11. The server according to claim 10, wherein the detection module is further used for detecting whether the cursor is located in the item display area within the video image in the following steps:
searching the video image in the preset database;
acquiring position features of the item display area within the video image found; and
detecting whether the cursor is located in the item display area within the video image based on the position features and the position of the cursor.

12. A terminal, comprising:
a position acquisition module for acquiring a video image and a position of a cursor in the video image;
an information acquisition module for acquiring item information associated with an item display area when the cursor is located in the item display area within the video image; and
an information presentation module for presenting the item information.

13. The terminal according to claim 12, wherein the information acquisition module is further used for acquiring the item information associated with the item display area in the following steps:
searching the video image in a preset database;
acquiring position features of the item display area within the video image found;
detecting whether the cursor is located in the item display area within the video image based on the position features and the position of the cursor; and
if yes, acquiring the item information associated with the item display area from the preset database.

14. The terminal according to claim 12, wherein the information acquisition module is further used for acquiring the item information associated with the item display area in the following steps:
sending the video image and the position of the cursor to a server; and
receiving, the item information associated with the item display area sent by the server, when the cursor is located in the item display area within the video image.

15. The terminal according to claim 12, further comprising:
a pause module for pausing a video in response to the presenting the item information; and
a continue-playing module for continuing the video in response to closing a display page of the item information.

16. The terminal according to claim 12, wherein if item information of a plurality of items is acquired, the information presentation module is also used for:
presenting the item information about some or all of the items in the video image in sequence based on a matching score between each item image of the items and the item display area.

17. The terminal according to claim 12, wherein the item information comprises at least one of the following: an item image, an item name, an item model, an item price and a purchase link.

18. An apparatus for constructing a database, comprising:
an image acquisition module for acquiring a video image;
an image determination module for determining whether the video image contains an item display area;
a feature determination module for determining position features and image features of the item display area in response to the video image containing the item display area;
an information acquisition module for acquiring item information associated with the item display area from a network based on the image features; and
a data storage module for storing the video image containing the item display area and corresponding position features and item information in a preset database.

19. A non-volatile computer storage medium storing one or more programs, the one or more programs when executed by an apparatus, enabling the apparatus to perform:
acquiring a video image and a position of a cursor in the video image;
detecting whether the cursor is located in an item display area within the video image based on the position of the cursor;
if yes, acquiring item information associated with the item display area from a preset database; and
sending the item information to a terminal for the terminal to present the item information.

20. A non-volatile computer storage medium storing one or more programs, the one or more programs when executed by an apparatus, enabling the apparatus to perform:
acquiring a video image and a position of a cursor in the video image;
acquiring item information associated with an item display area when the cursor is located in the item display area within the video image; and
presenting the item information.

21. A non-volatile computer storage medium storing one or more programs, the one or more programs when executed by an apparatus, enabling the apparatus to perform:
acquiring a video image;
determining whether the video image contains an item display area;
if yes, determining position features and image features of the item display area;
acquiring item information associated with the item display area from a network based on the image features; and
storing the video image containing the item display area and corresponding position features and item information in the preset database.
